(19) United States
(12) Patent Application Publication
(10) Pub. No.: US 2008/0028290 A1
(43) Pub. Date: Jan. 31, 2008

(54) DYNAMIC COLUMN ADJUSTMENT

(76) Inventor: MICHAEL SUWIRYO, Milford, OH (US)

Correspondence Address: UGS CORP., 5800 GRANITE PARKWAY, SUITE 600, PLANO, TX, 75024, US

(21) Appl. No.: 11/460,995

(22) Filed: Jul. 30, 2006

(51) Int. Cl. G06F 17/00

(52) U.S. Cl. 715/227; 715/255; 715/228

(57) ABSTRACT

A system, method, and computer program for adjusting a column in a table, comprising the steps of defining a plurality of resizing columns; defining a plurality of data columns; selecting one of said resizing columns; and moving individually, said selected resize column whereby a column width of at least one of said data columns is adjusted and appropriate means and computer-readable instructions.

### TECHNICAL FIELD

The presently preferred embodiment of the innovations described herein relate generally to displaying dynamic content on a web page. More specifically, the presently preferred embodiment relates to a dynamic column adjustment in a table widget.

### BACKGROUND

Web pages have typically displayed static content derived from HTML coding by web programmers. Not until recently has web programming evolved from the simplistic content formatting into content programming. Content programming allows the integration of familiar programming languages like PHP, PERL and JAVA, for example, with formatting available in HTML coding standards.

The increasingly sophisticated web-based applications necessitate the change from static HTML pages to dynamic interactive applications such as JavaServer Pages™ (ASP) technology developed by Sun Microsystems, Inc. JSP technology speeds the development of dynamic web pages by separating content generation from presentation, emphasizing reusable components, and simplifying page development. When integrated with the Java 2 Platform, Enterprise Edition (J2EE) and Enterprise JavaBeans technology, JSP pages provide enterprise-class scalability and performance necessary for deploying web-based applications across a virtual enterprise, such as Teamcenter Enterprise by UGS Corp.

While the evolution of web-application development has benefited programmers and designers, it has also benefited the end user as well, particularly when viewing displayed data in a table format. For example, if columns are not properly spaced, then important data may be obscured from the user's view, or columns might appear too wide and distort the view on a web page. Client side javascripts, like the script available from ActiveWidgets.com, exist to superficially resolve this problem. The ActiveWidgets solution uses what is known as Grid Control that applies a two-dimensional javascript array structure to store data. While the ActiveWidget solution has a similar look/feel to other commercially available spreadsheet applications, it lacks the ability to resize an adjusted column back to a preferred/initial width.

What is needed is an enhanced table widget to allow dynamic adjustable columns thereby improving the table user interface behavior and maintaining design integrity.

### SUMMARY

To achieve the foregoing, and in accordance with the purpose of the presently preferred embodiment as broadly described herein, the present application provides a method of adjusting a column in a table, comprising the steps of defining a plurality of resizing columns; defining a plurality of data columns; selecting one of said resizing columns; and moving individually, said selected resize column whereby a column width of at least one of said data columns is adjusted. The method, further comprising the step of alternating one of said resizing columns positioned adjacent to one of said plurality of data columns. The method, wherein the width of said column is adjusted in the horizontal direction. The method, wherein the width of said column is adjusted by moving a visual cursor of a pointing device. The method, wherein any of said data columns is returned to an initial column width by acting upon an adjacent resizing column. The method, wherein each of said resizing columns appear as an internal vertical border between said plurality of data columns. The method, wherein said selecting step further comprises depressing a mouse button on a pointing device. The method, wherein said moving step further comprises dragging one of said resizing columns in the horizontal direction.

Another advantage of the presently preferred embodiment is to provide a table for displaying a plurality of data in a plurality of rows and a plurality of columns, comprising: at least one data column; at least one resizing column; and said at least one data column adjacent to said at least one resizing column; whereby selecting at least one of said resizing columns to move individually, a column width of said at least one data columns adjacent to said selected resizing column.

And another advantage of the presently preferred embodiment is to provide a computer-program product tangibly embodied in a machine readable medium to perform a method, comprising instructions for defining a plurality of resizing columns; instructions for defining a plurality of data columns instructions for selecting one of said resizing columns; and instructions for moving individually, said selected resize column whereby a column width of at least one of said data columns is adjusted. The computer-program product, further comprising the instructions for alternating one of said resizing columns positioned adjacent to one of said plurality of data columns. The computer-program product, wherein the width of said column is adjusted in the horizontal direction. The computer-program product, wherein the width of said column is adjusted by moving a visual cursor of a pointing device. The computer-program product, wherein any of said data columns is returned to an initial column width by acting upon an adjacent resizing column. The computer-program product, wherein each of said resizing columns appear as an internal vertical border between said plurality of data columns. The computer-program product, wherein said selecting step further comprises depressing a mouse button on a pointing device. The computer-program product, wherein said moving step further comprises dragging one of said resizing columns in the horizontal direction.

And still another advantage of the presently preferred embodiment is to provide a data processing system having at least a processor and accessible memory to implement a method for dynamic column adjustment, comprising means for defining a plurality of resizing columns; means for defining a plurality of data columns; means for selecting one of said resizing columns; and means for moving individually, said selected resize column whereby a column width of at least one of said data columns is adjusted.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a block diagram of a computer environment in which the presently preferred embodiment may be practiced;

FIG. 2 is an exemplary diagram of a widget architecture;

FIG. 3 is a representation of an interaction between a template javaserver page and a references javascript page;

FIG. 4 is a representation of the effects of an implementation of the presently preferred embodiment;

FIG. 5 is a flowchart of a representation of a PrepareColumnForResize function;

FIG. 6 is a flowchart of a representation of a resizeColumn function;

FIG. 7 is a flowchart of a representation of a DisableMouseMovement function; and

FIGS. 8a-8d illustrate a representation of the presently preferred embodiment.

### DETAILED DESCRIPTION OF THE PREFERRED EMBODIMENTS

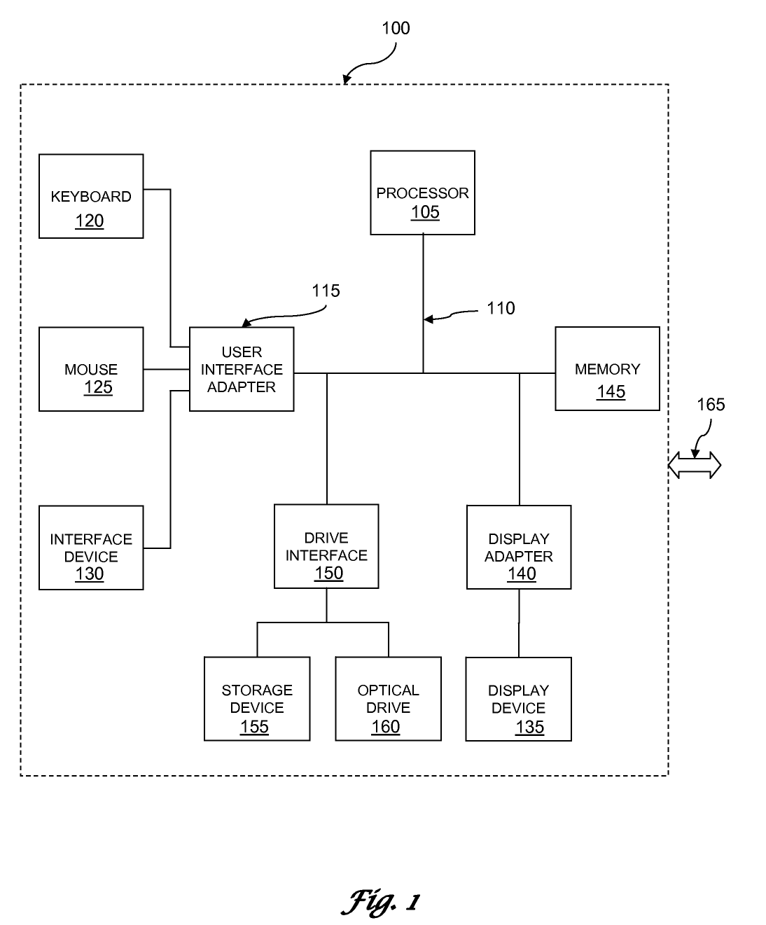

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method of dynamic column adjustment in a table widget. Now therefore, in accordance with the presently preferred embodiment, an operating system executes on a computer, such as a general-purpose personal computer. FIG. 1 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types. The presently preferred embodiment may be performed in any of a variety of known computing environments.

With reference to FIG. 1, an exemplary system for implementing the presently preferred embodiment includes a general-purpose computing device in the form of a computer 100, such as a desktop or laptop computer, including a plurality of related peripheral devices (not depicted). The computer 100 includes a microprocessor 105 and a bus 110 employed to connect and enable communication between the microprocessor 105 and a plurality of components of the computer 100 in accordance with known techniques. The bus 110 may be any of several types of bus structures including a memory bus or memory controller, a peripheral bus, and a local bus using any of a variety of bus architectures. The computer 100 typically includes a user interface adapter 115, which connects the microprocessor 105 via the bus 110 to one or more interface devices, such as a keyboard 120, mouse 125, and/or other interface devices 130, which can be any user interface device, such as a touch sensitive screen, digitized pen entry pad, etc. The bus 110 also connects a display device 135, such as an LCD screen or monitor, to the microprocessor 105 via a display adapter 140. The bus 110 also connects the microprocessor 105 to a memory 145, which can include ROM, RAM, etc.

The computer 100 further includes a drive interface 150 that couples at least one storage device 155 and/or at least one optical drive 160 to the bus. The storage device 155 can include a hard disk drive, not shown, for reading and writing to a disk, a magnetic disk drive, not shown, for reading from or writing to a removable magnetic disk drive. Likewise the optical drive 160 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 100.

The computer 100 can communicate via a communications channel 165 with other computers or networks of computers. The computer 100 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 145 of the computer 100. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

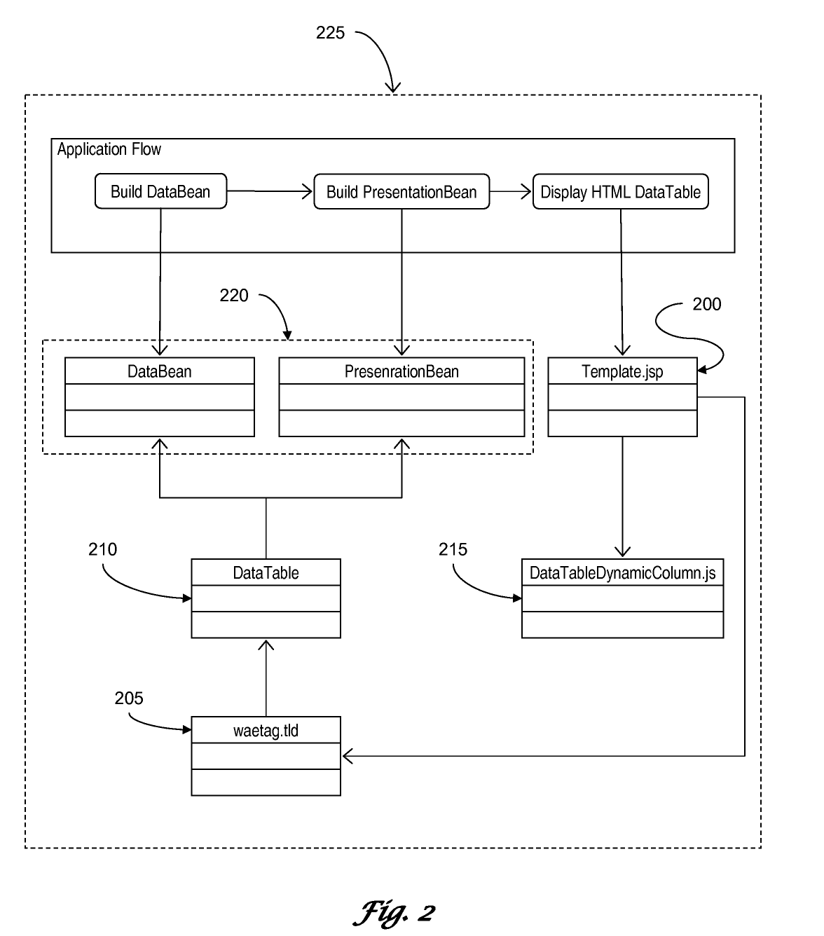

FIG. 2 is an exemplary diagram of a widget architecture employed in an implementation of the presently preferred embodiment. As shown in FIG. 2, a server that includes a Java Virtual Machine (JVM) 225 takes a JavaServer Page (ASP) web page 200 requested by a web client and reads custom JSP tags of the JSP web page 200 to determine if a widget is identified in the JSP web page 200. The JSP web page 200 is identified by a “.jsp” extension, and the widget is identified by a tag that begins with the prefix identified when registering the tag library definition (.tld) file at the top of the JSP web page 200, e.g., waetag.tld 205.

If a browser widget is identified, the JVM 225 constructs a tag object, e.g., DataTable 210, from a tag class that is a subclass of the Java Enterprise Edition Specification class and registered to the widget in the waetag.tld 205. The tag object generates the JavaScript object(s) for the widget and outputs the JavaScript object to the HTML response stream for the JSP Web page 200.

In generating the object, the tag object in the JVM 225 generates a JavaScript script block that links the appropriate JavaScript (.js) file 215 containing the JavaScript class definition for the widget and a JavaScript script block that constructs the widget JavaScript object using the class definition and sets the variable name of the construction in the widget object. The tag object in the JVM 225 also determines whether there are any JavaBeans 220 from a server-side model referenced in the attributes of a custom JSP tag and passed to the tag object by the JVM 225. If there are JavaBeans 220 referenced by the widget tags, these JavaBeans 220 are converted to a JavaScript representation of the JavaBean which is encapsulated in the widget object.

In an alternate embodiment, to support DataTable 210, a datatablescript tag can be used to set all of the client side javascript global variables and all necessary javascript libraries to support client side javascript features. In yet another embodiment, to support DataTable 210, a javascript manager could be used where the JSP page will only need to call the javascript manager in the beginning of a page to access various javascript variables and libraries.

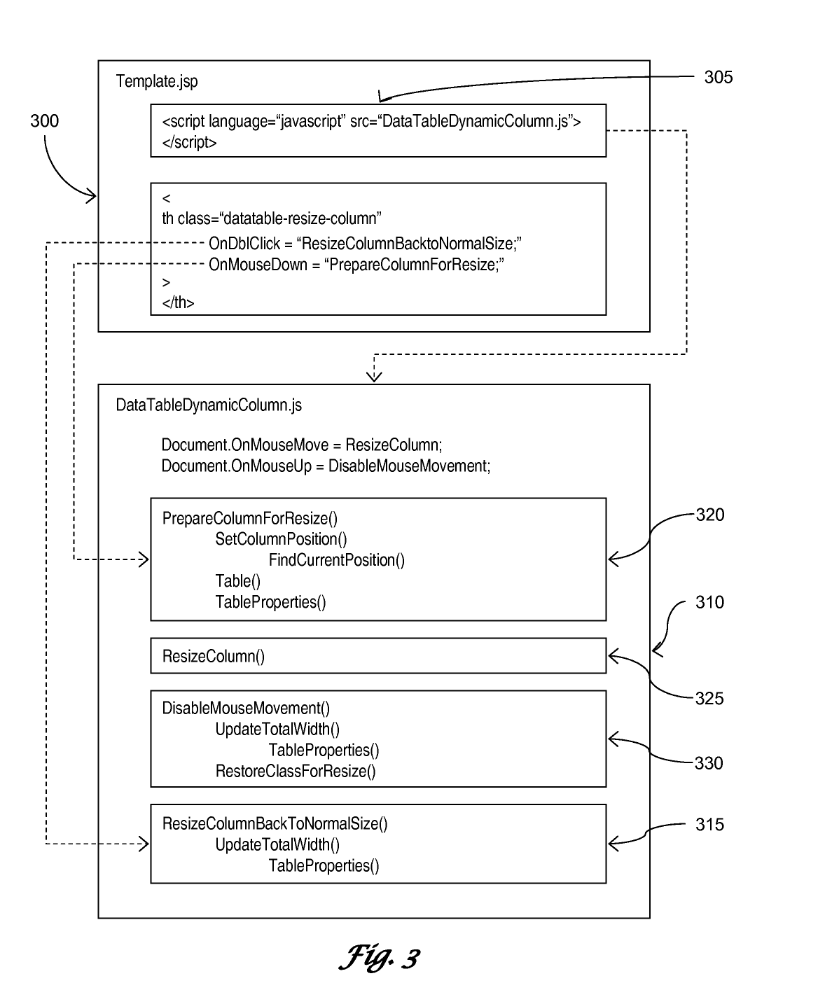

FIG. 3 is a representation of an interaction between a template javaserver page and a referenced javascript page. As shown in FIG. 3, the JSP web page 200 is identified as a template.jsp file 300 with the generated JavaScript script block 305 calling a DataTabelDynamicColumn.js file 310 when referenced in the viewed template.jsp file 300. As is understood in the art, calls to various functions defined within the DataTabelDynamicColumn.js file 310 are referenced in the table header <th>,</th> element utilized in tables on a web page. Also well understood in the art are events that manipulate the JSP web page 200, e.g., OnDblClick, OnMouseDown, OnMouseMove, and OnMouseUp, in the following syntax: inline HTML, event properties, or named scripts, for example.

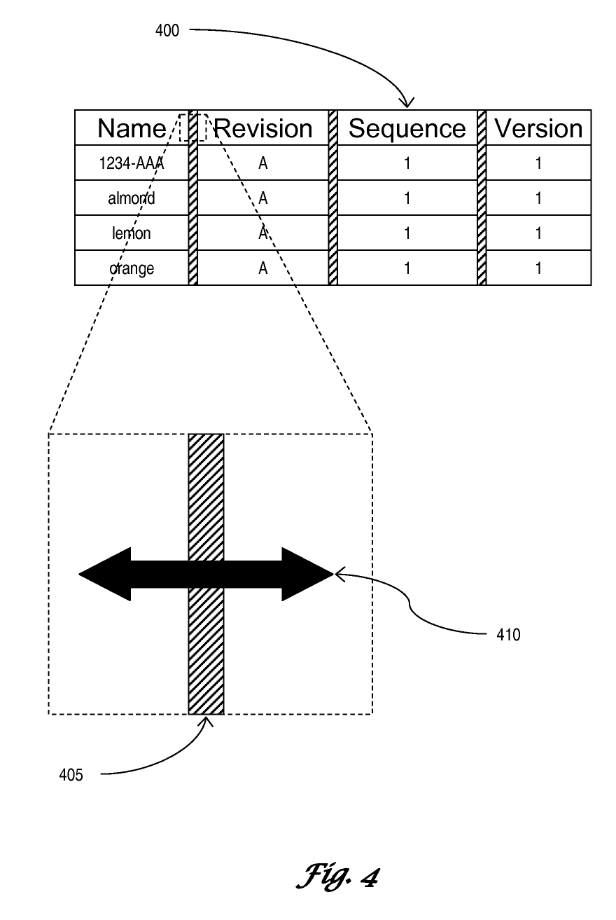

FIG. 4 is a representation of the effects of an implementation of the preferred embodiment on the pointing device. As shown in FIG. 4, when the user navigates the web page having a table 400 with a series of columns where dynamic data columns alternate with a plurality of static resize columns 405, and the user presses down the button of the pointing device on one of the resize columns 405, the JSP web page 200 calls an OnMouseDown event that does two things: (1) it changes a visual cursor to a move cursor, e.g., an arrow to a double-arrow 410, respectively, and (2) it calls a PrepareColumnForResize function 320 to set all proper objects for resizing the columns, as described in more below.

When the user moves the pointing device with the depressed button to the left or right, the JSP web page 200 calls an OnMouseMove event that calls a ResizeColumn function 325 to set a new position of the resized columns, as described in more detail below. Next, when the user removes pressure from the depressed button of the pointing device, the JSP web page 200 calls an OnMouseUp event that calls a DisableMouseMovement function 330 to set the resized columns and reset the visual cursor to normal pointing functionality, as described in more detail below. Should the user desire to return the resized columns to an original programmed width, the user performs a double-click with the pointing device so that the Javascript encoded page calls an OnDblClick event that calls a ResizeColumnBacktoNormalSize function 315, as described in more detail below.

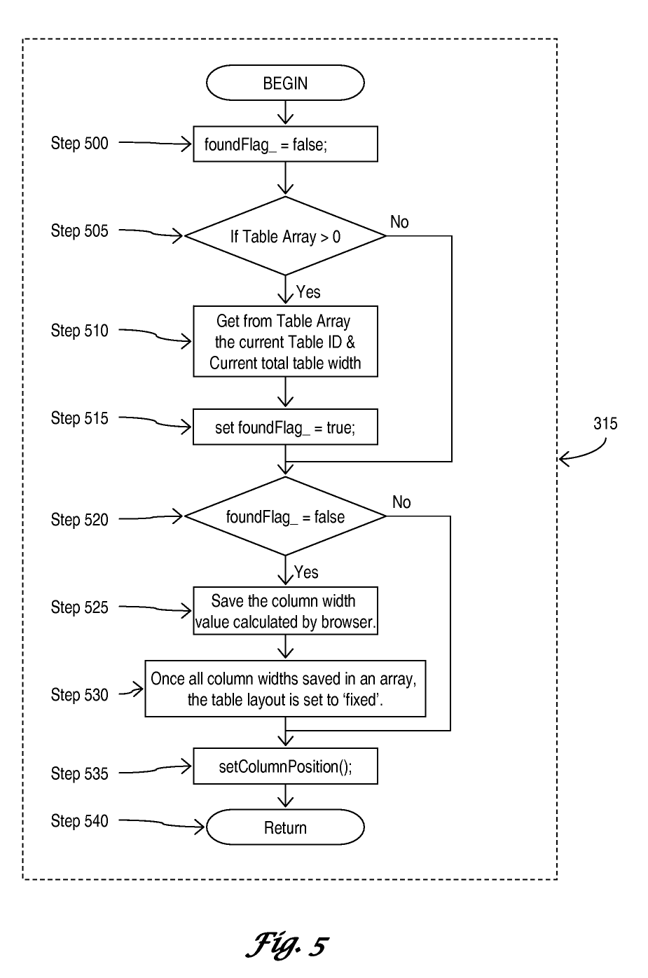

FIG. 5 is a flowchart of a representation of the PrepareColumnForResize function 320 in more detail. Variables sent from the template.jsp page 300 to the PrepareColumnForResize function 320 include a table id, a resizer column, a left column, a right column, and a total column number. As shown in FIG. 5, a FoundFlag variable is set to FALSE, and RESIZER is set to the value of the resizer column (Step 500). If a table array value is positive (Step 505), the function retrieves the table id and table width. (Step 510), and FoundFlag is set to TRUE (Step 515). If, however, the table array value is ZERO or NEGATIVE (Step 500), then check if FoundFlag is FALSE (Step 520), and if so, then a browser calculated column width value is saved (Step 525). Once all column widths are saved in a width array, the table layout is set to a fixed value (Step 530). Next, the column position is set by a setColumnPosition function (Step 535). If FoundFlag is NOT FALSE (Step 520), then Steps 525 & 530 are bypassed, proceeding on to set the next column position (Step 535).

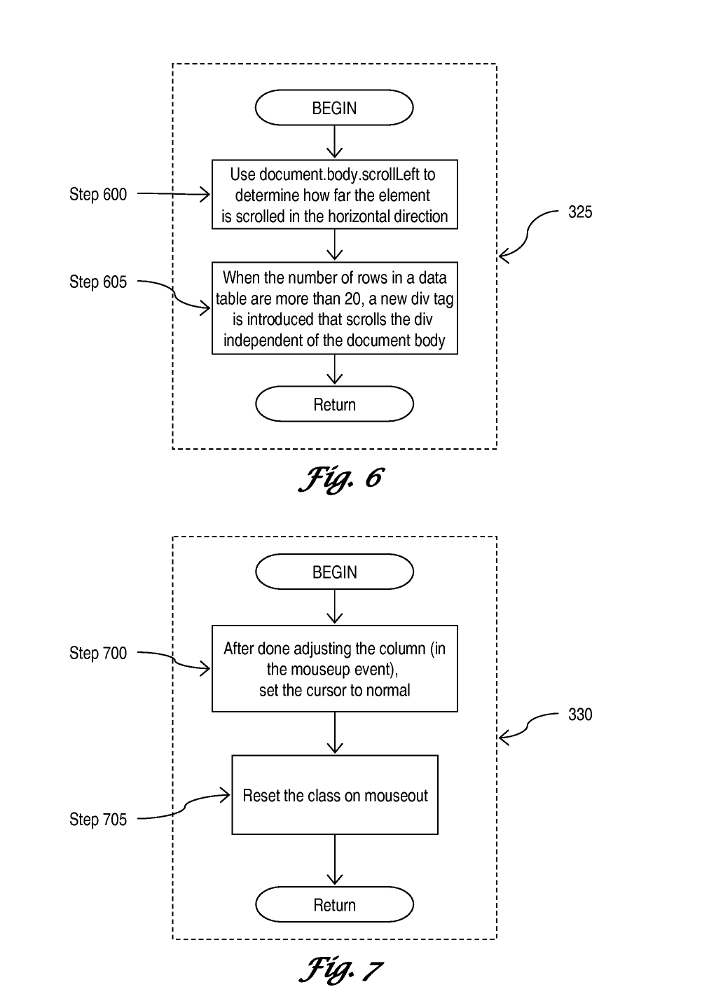

FIG. 6 is a flowchart of a representation of the resizeColumn function 325. As shown in FIG. 6, the new position for the resized columns is set by determining how for the resize column is scrolled in the horizontal direction (Step 600). Also when the number of rows in the table exceeds 20, a new div tag is created to scroll it independently from the body of the table (Step 605).

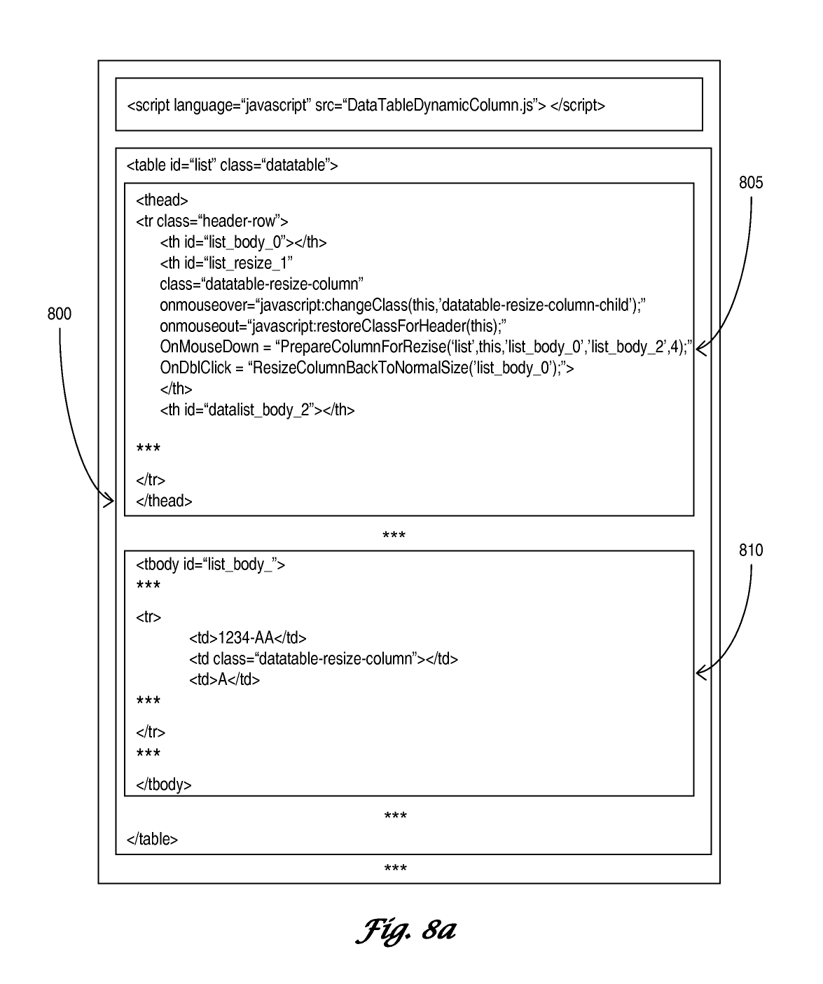

FIG. 7 is a flowchart of a representation of the DisableMouseMovement function 330. As shown in FIG. 7, after adjusting the resizer column, the visual cursor is set to normal operation, i.e., appearing as the arrow (Step 700). Reset the resize class for future use, on mouseout (Step 705).

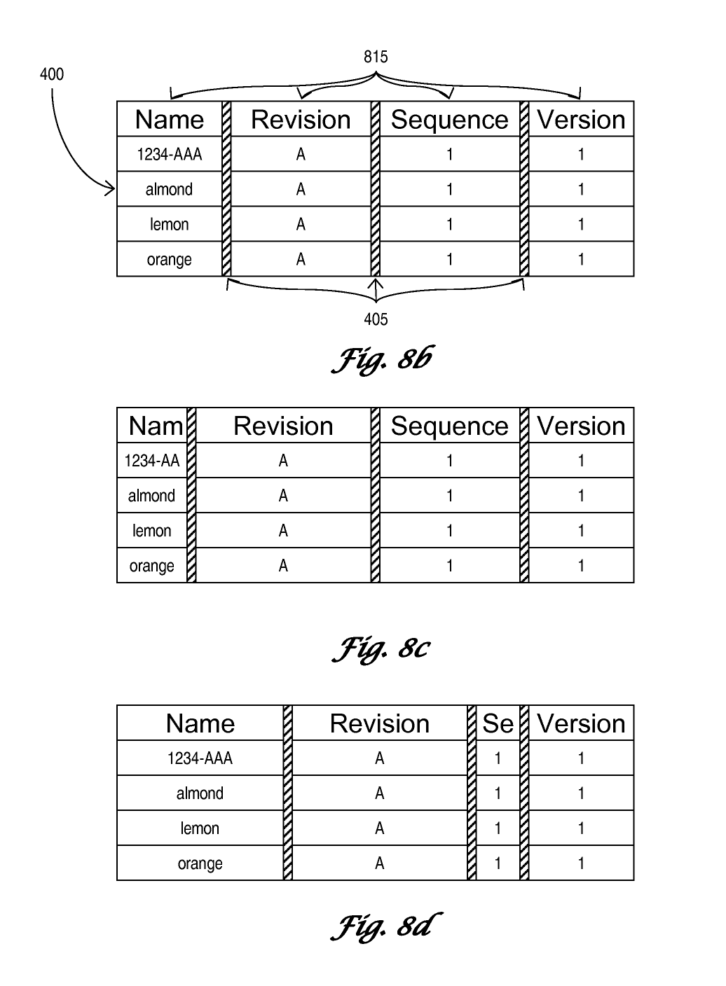

FIGS. 8a-8d illustrate a representation of the presently preferred embodiment. The user views a sample web page as shown in HTML code at the sample code 800 that displays the table 400. As is known in the art of HTML coding: a <table></table> tag pair allows the arrangement of data into rows and columns of cells in a generic table; a <thead></thead> tag pair defines a group of header rows in the generic table, generally shown in a thead block 805; a <tbody></tbody> tag pair defines a group of data rows in the generic table, generally shown in a tbody block 810; a <tr></tr> tag pair defines a table row in the generic table; a <th></th> tag pair defines a header cell in the generic table; and a <td></td> tag pair defines a data cell in the generic table. Each table row <tr>,</tr> can have one or both <th>,</th> and <td></td> tag pairs containing, typically, information in a 1 to 1 ratio. That is, all things being equal, the number of columns are static in any given table, such that each row has the same number of columns, for example. A more complete reference is at www.w3.org, the standards body for the World Wide Web.

Turning now to the table 400, which has four (4) columns of data 815 and three (3) resizing columns 405, there is HTML code in the thead block 805 where header information for each of the first three columns (1 data column, 1 resizing column, and 1 data column) is defined and corresponds to data information for each of the said three columns as defined in the tbody block 810. Examining the thead block 805 in conjunction with the tbody block 810 that contains the data, column 1 is a data column 815 identified with a column id of “list_body_{—}0” and having the data “1234-AAA.” Likewise, column 2 is a resizing column 425 identified with the column id of “list_resize_{—}1”, a class identification of “datatable-resize-column” and javascript code that calls the disclosed presently preferred embodiment; having the data class equal “datatable-resize-column.” And column 3 is another data column 815 identified with a column id of “list_body_{—}2” and having the data “A.” While column 2 contains no data visible by the user, the actions performed on column 2 are governed by the javascript function calls identified in the thead block 805 and referenced in the tbody block 810. As the user single clicks the pointing device on the resizing column 405, the following values are sent to the PrepareColumnForResize function 315: the table id is “list”, the resizer column is “this”, the left column is “list_body_{—}0”, the right column is “list_body_{—}2”, and the total column number is 4, generally referenced in the thead block 805.

Functionally, as the user moves the resizing columns 405 by the disclosed method the effect is illustrated in FIGS. 8c & 8d. To return to the original programmed view of the table 400, the user performs a double click on the resize column 405.

### CONCLUSION

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments have been described. It will be understood that various modifications may be made without departing from the spirit and scope of the presently preferred embodiment, such as creating adjustable rows, or entire table structures that can be resized with a double click on the border. Further, the dynamic adjustment of the resize columns can have various effects on the data in the data columns, like word wrap or character truncating, for example. Therefore, other implementations are within the scope of the following claims.

What is claimed is:

1. A method of adjusting a column in a table, comprising the steps of:
defining a plurality of resizing columns;
defining a plurality of data columns;
selecting one of said resizing columns; and
moving individually, said selected resize column whereby a column width of at least one of said data columns is adjusted.

2. The method of claim 1, further comprising the step of alternating one of said resizing columns positioned adjacent to one of said plurality of data columns.

3. The method of claim 1, wherein the width of said column is adjusted in the horizontal direction.

4. The method of claim 1, wherein the width of said column is adjusted by moving a visual cursor of a pointing device.

5. The method of claim 1, wherein any of said data columns is returned to an initial column width by acting upon an adjacent resizing column.

6. The method of claim 1, wherein each of said resizing columns appear as an internal vertical border between said plurality of data columns.

7. The method of claim 1, wherein said selecting step further comprises depressing a mouse button on a pointing device.

8. The method of claim 1, wherein said moving step further comprises dragging one of said resizing columns in the horizontal direction.

9. A table for displaying a plurality of data in a plurality of rows and a plurality of columns, comprising:
at least one data column;
at least one resizing column; and
said at least one data column adjacent to said at least one resizing column;
whereby selecting at least one of said resizing columns to move individually, a column width of said at least one data columns adjacent to said selected resizing column.

10. A computer-program product tangibly embodied in a machine readable medium to perform a method, comprising:
instructions for defining a plurality of resizing columns;
instructions for defining a plurality of data columns instructions for selecting one of said resizing columns; and
instructions for moving individually, said selected resize column whereby a column width of at least one of said data columns is adjusted.

11. The computer-program product of claim 10, further comprising the instructions for alternating one of said resizing columns positioned adjacent to one of said plurality of data columns.

12. The computer-program product of claim 10, wherein the width of said column is adjusted in the horizontal direction.

13. The computer-program product of claim 10, wherein the width of said column is adjusted by moving a visual cursor of a pointing device.

14. The computer-program product of claim 10, wherein any of said data columns is returned to an initial column width by acting upon an adjacent resizing column.

15. The computer-program product of claim 10, wherein each of said resizing columns appear as an internal vertical border between said plurality of data columns.

16. The computer-program product of claim 10, wherein said selecting step further comprises depressing a mouse button on a pointing device.

17. The computer-program product of claim 10, wherein said moving step further comprises dragging one of said resizing columns in the horizontal direction.

18. A data processing system having at least a processor and accessible memory to implement a method for dynamic column adjustment, comprising:
means for defining a plurality of resizing columns;
means for defining a plurality of data columns;
means for selecting one of said resizing columns; and
means for moving individually, said selected resize column whereby a column width of at least one of said data columns is adjusted.
